(19) United States
(12) Patent Application Publication
(10) Pub. No.: US 2005/0209860 A1
(43) Pub. Date: Sep. 22, 2005

(54) Itinerary search method

(75) Inventors: Dominique Beaufort, Suresnes (FR); Laurent Fay, La Frette sur Seine (FR); Christophe Samson, Paris (FR)

Correspondence Address: PHILIPS INTELLECTUAL PROPERTY & STANDARDS, P.O. BOX 3001, BRIARCLIFF MANOR, NY, 10510, US

(73) Assignee: Koninkijke Philips Electronics N.V.

(21) Appl. No.: 10/517,475

(22) PCT Filed: Jun. 4, 2003
(86) PCT No.: PCT/IB03/02464

§ 371 Date: Dec. 7, 2004

(30) Foreign Application Priority Data
Jun. 11, 2002 (FR) 0207151

(51) Int. Cl. G06F 17/60

(52) U.S. Cl. 705/1

(57) ABSTRACT

The invention relates to an itinerary search method comprising a step of computing the itinerary from a criterion defined by a user (for example, a point of departure and a point of arrival) and a step of selecting service providers along the computed itinerary, said services being defined by the user.

The invention relates to a system comprising at least a communication network, a user entity and a server entity, in which the user entity transmits requests relating to services to a server entity and receives responses indicating service providers originating from said server entity.

The invention also relates to a server entity intended to be used in such a system.

It also relates to a method of searching service providers, and a program comprising instructions for performing such a method.

It finally relates to a signal conveying a search request transmitted to such a server entity, as well as a signal conveying a response transmitted by such a server entity.

International patent application WO 96/36193 describes a system in which a mobile user entity transmits a request relating to a service through a network in order to be guided to a service provider who proposes said service and who is in the proximity of the mobile user entity.

The invention proposes a different type of system with which service providers can also be found.

A system according to the invention comprises at least a network, a user entity and a server entity, said user entity comprising:
means for defining at least one itinerary search criterion and at least one service;
means for sending an itinerary search request to said server entity via said communication network, said request comprising at least said search criterion and said service;
means for receiving a response via said communication network;
means for presenting said response,
   said server entity comprising:
means for receiving said itinerary search request;
means for computing at least one itinerary from said search criterion by using a transport database;
means for selecting at least one provider providing said service and fulfilling at least one proximity condition with respect to the computed itinerary by using a database of service providers;
means for sending, to said user entity via said communication network, a response comprising the computed itinerary with localization of the selected provider.

A server entity according to the invention comprises:
means for receiving an itinerary search request, said request comprising at least one search criterion and at least one service;
means for computing at least one itinerary from said search criterion by using a transport database;
means for selecting at least one provider providing said service and fulfilling at least one proximity condition with respect to the computed itinerary by using a database of service providers;
means for sending a response comprising the computed itinerary with localization of the selected provider.

A search method according to the invention comprises the steps of
defining at least one itinerary search criterion and at least one service;
computing at least one itinerary responding to said search criterion by using a transport database;
selecting at least one provider providing said service which fulfills at least one proximity condition with respect to the computed itinerary by using a database of service providers;
presenting the computed itinerary with localization of the selected provider.

A signal according to the invention conveys:
a search request comprising at least one itinerary search criterion and at least one service, said request being addressed to a server entity according to the invention;
or a response to a search request, said response being sent by a server entity according to the invention and comprising at least one itinerary with localization of at least one service provider.

According to the invention, an itinerary responding to certain criteria is first computed and subsequently service providers situated in the proximity of the computed itinerary are selected. In other words, the service providers are not searched with respect to the current localization of the user entity, as is the case in the above-mentioned prior art, but with respect to an itinerary which the user entity is going to follow. It is not a matter of moving about for the purpose of accessing a service but of benefiting from moving about so as to access a service.

The itinerary search criteria are, for example, a point of departure and a point of arrival, or the current localization of the user entity and a point of arrival. A transport mode (on foot, by car, by bus, by metro . . . ) may also be defined.

When a transport mode is defined as the itinerary search criterion, said proximity condition is adapted as a function of said mode transport. For example, the service provider may be nearer to the computed itinerary if the user moves about on foot rather than by car. Similarly, the service provider may be near a bus or metro station when the user moves about by bus or metro.

Advantageously, said proximity condition is also adapted to the types of zones traversed by the itinerary. For example, in a part of the itinerary situated in a country zone, the service provider may be further away than in a part of the itinerary situated in town.

These and other aspects of the invention are apparent from and will be elucidated, by way of non-limitative example, with reference to the embodiment(s) described hereinafter.

In the drawings:

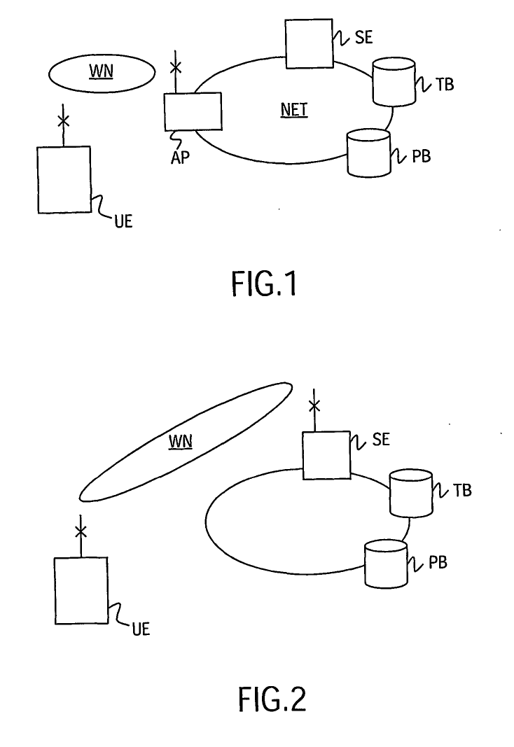

FIG. 1 is a diagram of a first example of the system according to the invention;

FIG. 2 is a diagram of a second example of the system according to the invention;

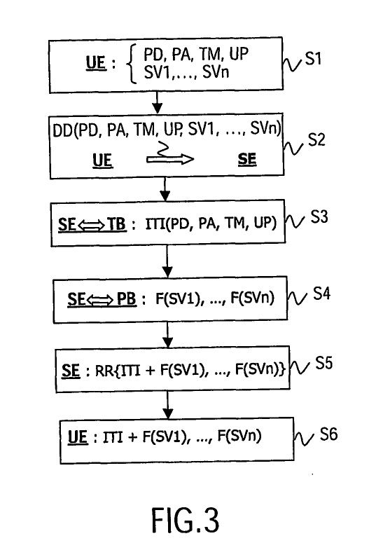

FIG. 3 is a diagram showing steps of an itinerary search method according to the invention;

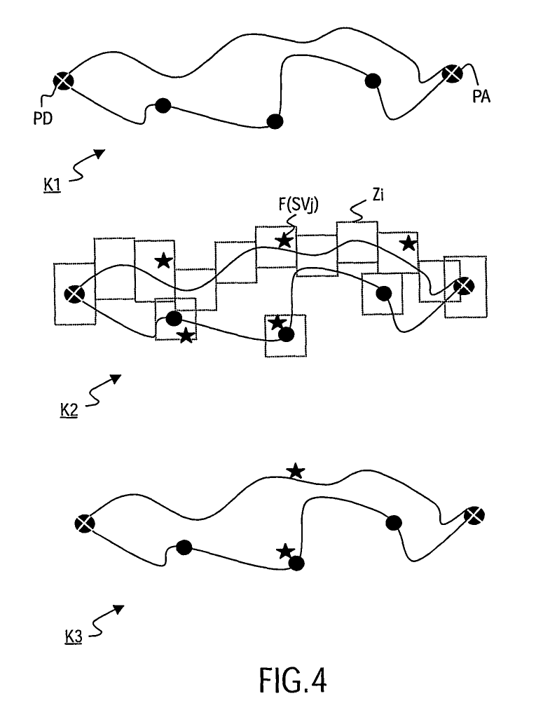

FIG. 4 is a diagram elucidating the mode of determining service providers fulfilling the proximity condition.

FIG. 1 shows an example of the system according to the invention, which comprises a user entity UE, a communication network NET, a server entity SE, a transport database TB and a service provider database PB. The server entity SE has access to the databases TB and PB via the communication network NET. The user entity UE is a mobile entity provided with radio communication means. It has access to the communication network NET via a radio access point AP.

In FIG. 2, the mobile user entity UE has direct access to the server entity SE via a radio connection without passing through the communication network NET.

In the embodiments shown in FIGS. 1 and 2, the transport database TB and the service provider database PB are distinct from the server entity SE. This is not limitative. One of the databases (or the two databases) may be locally stored at the level of the server entity SE.

For example, the communication network NET is the Internet and the communications by radio take place via a radio communication network WN in conformity with the GPRS or the UMTS standard.

In another embodiment (not shown) the user entity UE is a fixed entity connected to the Internet via a telephone line and a modem, or via a high-rate digital line. For example, it may be an automat put at the disposal of the public, or a personal computer.

FIG. 3 shows an example of the itinerary search method according to the invention, comprising 6 steps enumerated S1 to S6.

In step S1, a user defines at least one itinerary search criterion, as well as several services SV1, . . . SVn which he wishes to access.

In a first embodiment, the user takes a point of departure PD and a point of arrival PA. In a second embodiment, the user entity UE is provided with means for determining its current position (for example, a device of the GPS type, or means for triangularization) and this current position constitutes the point of departure for the itinerary search.

Advantageously, the user also has the possibility of indicating a transport mode TM to be used, and/or a user preference UP intended to determine an optimal itinerary from various possible itineraries (for example, the user may choose time, distance, or costs as optimal criteria).

In a first variant of the invention, to define a service, the user orally or manually takes one or several words, for example, names of products or activities (bread, baker, doctor, hospital, bank, supermarket . . . ). In accordance with a second variant, he selects words from a predefined list.

Advantageously, the services may be defined at any instant by the user, independent of sending an itinerary search request. In this case, they are stored in a current list. When an itinerary search request is sent, the services in the current list are inserted in the request. The user can delete a service from the current list at any instant.

In step S2, a request DD is sent to the server entity SE. This request comprises at least one itinerary search criterion and one service. The itinerary search criterion comprises at least a point of departure PD and a point of arrival PA. Optionally, it also comprises a transport mode TM, and/or a user preference UP.

In step S3, the server entity SE computes an itinerary ITI from the search criterion or criteria comprised in the request (PD, PA, TM, UP). This computation is made by using the transport database TB. There are currently sites on the Internet that propose computations of itineraries from criteria defined by a user. This is, for example, the case with the site www.viamichelin.fr. For example, a computation mode which is similar to that used on these sites is used.

In step S4, the server entity SE selects for each service SVj (j=1, . . . , n) indicated in the itinerary search request, a provider F(SVj) who provides said service and fulfills a proximity condition with respect to the itinerary computed in step S3 by using the service provider database PB. Advantageously, the proximity condition is adapted as a function of said transport mode, and/or as a function of the types of traversed zones. An example of the provider selection mode will be described in detail hereinafter with reference to FIG. 4.

In step S5, the server entity SE elaborates a response RR which comprises the computed itinerary ITI with localization of the selected providers F(SVj). For example, the response consists of an electronic page comprising a graphical representation of the itinerary on which the providers are localized, and/or a list of stages and directions to be followed, in which the providers are mentioned at the appropriate stage.

In step S6, the user entity UE receives the response and presents it to the user. When the response has the form of an electronic page, it is displayed on a screen of the user entity UE. When the user entity UE is an automat at the disposal of the public, the response is advantageously printed in order that the user can take it with him.

FIG. 4 shows three series of two curves to explain the operation of the itinerary search method according to the invention.

In each series of curves, the high curve corresponds to the itinerary computed for transport by car and the low curve corresponds to the computed itinerary by using public transport. On the low curves, the stations at which the user may interrupt his journey are indicated by dots. The first series of curves K1 represents the itineraries computed in step S3. The second series of curves K2 represents an example of the mode of selecting a service provider, as performed in step S4. The third series of curves K3 represents the response elaborated in step S5.

The providers are selected, for example, in the following way. The service providers are stored in the service provider database PB per geographical zone. The geographical zones may have an arbitrary form. In FIG. 4, it is assumed that the geographical zones are rectangular. Each geographical zone is characterized by geographical co-ordinates.

As indicated in the second series of curves K2, the server entity defines rectangular search zones Zi along the computed itinerary, such that each search zone is approximately centered on the itinerary. As indicated on the low curves, when the itinerary has been computed by means of a public transport mode, the search zones are not defined around stations. The search zones are more or less large in accordance with the used transport mode and in accordance with the type of traversed geographical zone.

Advantageously, the user has the possibility to define a maximum distance between the services to be found and the computed trajectory. In this embodiment, the width of the search zones depends on this maximum distance defined by the user.

The server entity SE subsequently searches in the provider database PB whether there are providers who provide the service or services requested in the search zones thus defined.

As long as all the search zones have not been explored, the providers found are registered in the memory. In the second series of curves K2, the providers found are indicated by asterisks.

In a first example, when all the search zones have been explored, the server entity SE makes a selection from the providers which have been found. For example, for each service, one or several providers that are closest to the itinerary are selected. If several services have been requested, the providers are selected as a function of regrouping facilities.

In a second example, no selection is made. All the providers found are localized in the itinerary.

The third series of curves K3 only represents the selected providers.

Advantageously, an itinerary search method according to the invention is implemented in the form of a first program intended to be executed at the level of the user entity UE, and a second program intended to be executed at the level of the server entity SE.

The invention is not limited to the embodiments described by way of example. Modifications or improvements may be made for the system, the server entity, and the itinerary search method which have been described hereinbefore without departing from the scope of the invention.

Use of the verb “comprise” and its conjugations does not exclude the presence of elements or steps other than those stated in the claims.

1. A system comprising at least a communication network, a user entity and a server entity, said user entity comprising:
means for defining at least one itinerary search criterion and at least one service;
means for sending an itinerary search request to said server entity via said communication network, said request comprising at least said search criterion and said service;
means for receiving a response via said communication network;
means for presenting said response,
said server entity comprising:
means for receiving said itinerary search request;
means for computing at least one itinerary from said search criterion by using a transport database;
means for selecting at least one provider providing said service and fulfilling at least one proximity condition with respect to the computed itinerary by using a database of service providers;
means for sending, to said user entity via said communication network, a response comprising the computed itinerary with localization of the selected provider.

2. A server entity comprising:
means for receiving an itinerary search request, said request comprising at least one search criterion and at least one service;
means for computing at least one itinerary from said search criterion by using a transport database;
means for selecting at least one provider providing said service and fulfilling at least one proximity condition with respect to the computed itinerary by using a database of service providers;
means for sending a response comprising the computed itinerary with localization of the selected provider.

3. A search method comprising the steps of:
defining at least one itinerary search criterion and at least one service;
computing at least one itinerary responding to said search criterion by using a transport database;
selecting at least one provider providing said service which fulfills at least one proximity condition with respect to the computed itinerary by using a database of service providers;
presenting the computed itinerary with localization of the selected provider.

4. A search method as claimed in claim 3, wherein a transport mode is defined as the itinerary search criterion and said proximity condition is adapted as a function of said transport mode.

5. A search method as claimed in claim 3, wherein the computed itinerary traverses one or several zones each being of a certain type, and said proximity condition is adapted accordingly as a function of the type of traversed zones.

6. A search method as claimed in claim 3, characterized in that said step of defining the service can be executed independently of the itinerary computation, and in that the services defined are stored in a current list intended to be used during the itinerary computation.

7. A program comprising instructions for performing an itinerary search method as claimed in claim 3, when it is executed by a processor.

8. A signal conveying an itinerary search request comprising at least one itinerary search criterion and at least one service, said request being addressed to a server entity as claimed in claim 2.

9. A signal conveying a response to an itinerary search request, said response being sent by a server unit as claimed in claim 2 and comprising at least one itinerary with localization of at least one service provider.
